(19) United States
(12) Patent Application Publication
(10) Pub. No.: US 2007/0085756 A1
(43) Pub. Date: Apr. 19, 2007

(54) Attaching device for antenna

(75) Inventor: Yat To Chan, Taoyuan Hsien (TW)

Correspondence Address: CHARLES E. BAXLEY, ESQ., 90 JOHN STREET, THIRD FLOOR, NEW YORK, NY, 10038, US

(73) Assignee: Joymax Electronics., Co., Ltd.

(21) Appl. No.: 11/250,837

(22) Filed: Oct. 14, 2005

(51) Int. Cl. H01Q 1/50

(52) U.S. Cl. 343/906; 343/702

(57) ABSTRACT

An attaching device for attaching an antenna member to a coupling member of an electric facility includes a housing having a projection extended from one end for coupling to the antenna member, and another end for attaching to the electric facility, a casing is engaged into the housing and includes one end secured to the housing, and the other end for attaching to the coupling member of the electric facility, and a coupler is received in the casing and includes a conductive member engaged in a receptacle for electrically coupling to the coupling member of the electric facility and the antenna member, and for allowing the antenna member to be easily coupled to the coupling member of the electric facility.

### BACKGROUND OF THE INVENTION

1. Field of the Invention

The present invention relates to an attaching device, and more particularly to an attaching device having an improved structure for allowing antenna members to be easily and readily coupled to various electric facilities.

2. Description of the Prior Art

Typical electric facilities, such as radio and/or video facilities, vehicles, portable or mobile phones, electric game facilities, computer facilities, global systems for mobile communications, etc. may comprise one or more antenna devices attached or coupled thereto, for signals receiving and emitting and/or transmitting purposes.

For example, U.S. Pat. No. 5,973,645 to Zigler et al. discloses one of the typical portable or mobile phones comprising an antenna device attached or coupled thereto. However, a number of coupling members, such as bushings, retaining sleeves, retaining rings, shell portions, rotation limiters, etc. are required to be prepared to couple or to attach the antenna device to the typical portable or mobile phones, such that the antenna attaching device includes a complicated configuration that may greatly increase the manufacturing cost and the assembling processes thereof.

U.S. Pat. No. 6,518,928 to Sheu discloses another typical electric facility comprising an antenna device attached or coupled thereto with a coupling seat and a coupling housing. However, the coupling seat and the coupling housing include a configuration that may not be easily manufactured.

The present invention has arisen to mitigate and/or obviate the afore-described disadvantages of the conventional attaching devices for attaching antenna members to electric facilities.

### SUMMARY OF THE INVENTION

The primary objective of the present invention is to provide an attaching device for antenna including an improved structure for allowing antenna members to be easily and readily coupled to various electric facilities.

In accordance with one aspect of the invention, there is provided an attaching device for attaching an antenna member to a coupling member of an electric facility, the attaching device comprising a housing including a chamber formed therein, and including a first end having a projection extended therefrom, for coupling to the antenna member, and including a bore formed in the first end thereof, for receiving an electric cable therein, and including a second end for attaching to the electric facility, a casing engaged into the chamber of the housing, and secured to the housing, and including a first end having a bore formed therein for receiving the electric cable therein, and including a compartment formed therein, and including a second end for attaching to the coupling member of the electric facility, and a coupler received in the compartment of the casing, and including a receptacle engaged in the compartment of the casing, and a conductive member engaged in the receptacle for electrically coupling to the coupling member of the electric facility and the antenna member.

The housing includes a hook provided in the first end thereof, and the casing includes a stud extended therefrom for engaging with the hook, and for attaching the casing to the housing. The housing includes a protrusion extended into the chamber thereof from the first end thereof, and having the hook extended therefrom.

The stud of the casing is engaged into the protrusion of the housing, and includes a peripheral flange extended outwardly from the stud, for engaging with the hook of the housing, and for attaching the casing to the housing.

The housing includes at least one rib extended into the chamber thereof, fur engaging with the casing and for attaching the casing to the housing. The casing includes at least one notch formed therein for receiving the rib of the housing. The casing includes an opening formed therein for viewing an inner portion of the casing.

The housing includes an enlarged space formed in the second end thereof, and having an inner diameter greater than that of the chamber thereof, for forming an inner peripheral shoulder therein, and the second end of the casing includes an outer diameter greater than that of the casing for forming an outer peripheral shoulder and for engaging with the inner peripheral shoulder of the housing, and for anchoring the casing to the housing.

The second end of the casing includes at least one slit for forming at least one spring blade and for increasing a resilience of the casing. The casing includes at least one protrusion extended outwardly from the second end thereof, for engaging with the housing and for stably anchoring the casing to the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial cross sectional view illustrating an attachment of an attaching device in accordance with the present invention for coupling an antenna member to an electric facility;

FIG. 2 is an enlarged cross sectional view of the attaching device for antenna;

FIG. 3 is an exploded and cross sectional view of the attaching device for antenna;

FIG. 4 is a plan view of an outer housing of the attaching device for antenna;

FIG. 5 is a bottom plan view of the outer housing of the attaching device taken along lines 5-5 of FIG. 4;

FIG. 6 is a plan view similar to FIG. 6, in which a portion of the outer housing of the attaching device has been cut off for showing an inner structure of the housing;

FIG. 7 is a plan view illustrating an inner casing of the attaching device; and

FIG. 8 is an enlarged cross sectional view illustrating the attachment of the attaching device to the electric facility.

### DETAILED DESCRIPTION OF THE PREFERRED EMBODIMENT

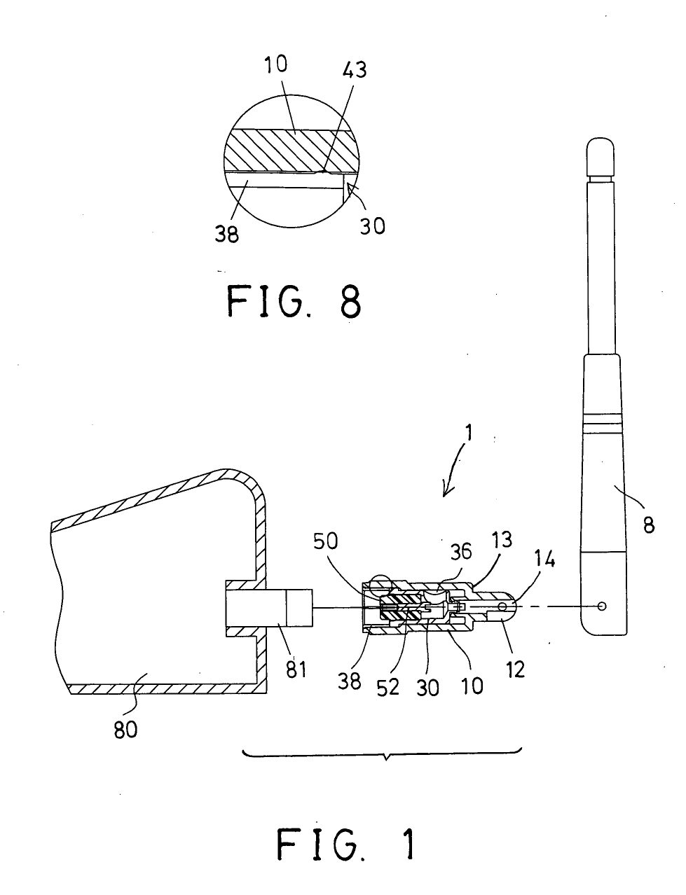

Referring to the drawings, and initially to FIG. 1, an attaching device 1 in accordance with the present invention is provided for attaching or for coupling an antenna member 8 to an electric facility 80, such as a radio and/or video facility, a vehicle, a portable or mobile phone, an electric game facility, a computer facility, a global system for mobile communication, etc., in which the electric facility 80 may include a plug or coupling member 81 extended therefrom for electrically coupling to the attaching device 1, and then to the antenna member 8.

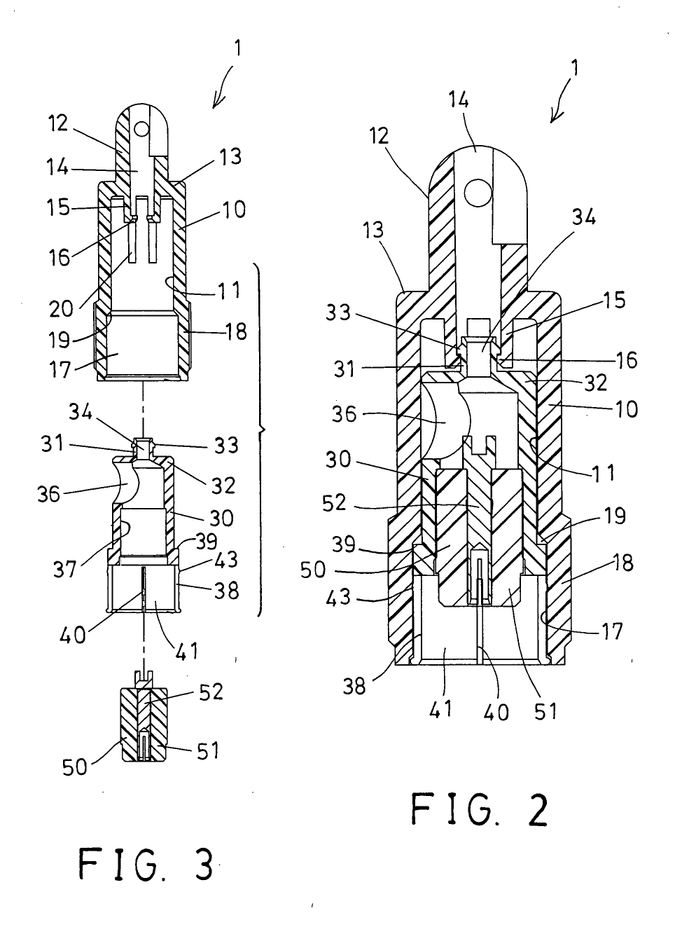

As shown in FIGS. 2-6, the attaching device 1 comprises a housing 10 including a chamber 11 formed therein, and including a projection 12 extended from one end 13 thereof, for rotatably or pivotally coupling or attaching to the antenna member 8, and including a bore 14 formed in the one end 13 thereof, for receiving such as electric wires or cables therein (not shown), and further including a peripheral protrusion 15 extended into the chamber 11 thereof from such as the one end 13 thereof. The protrusion 15 of the housing 10 includes a hook 16 formed or extended from or provided in the inner peripheral portion thereof, or extended into the bore 14 of the one end 13 of the housing 10.

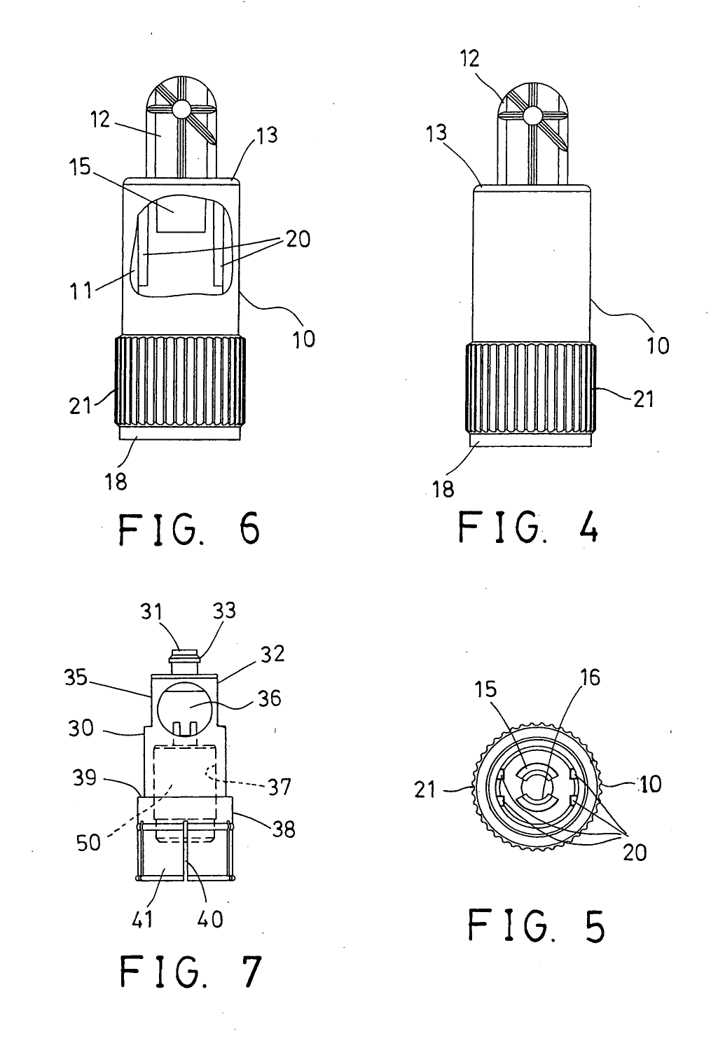

The housing 10 further includes an enlarged space 17 formed in the other end 18 thereof, for receiving and for attaching to the plug or coupling member 81 of the electric facility 80, and having an inner diameter greater than that of the chamber 11 thereof, for forming an inner peripheral shoulder 19 therein, and/or located between the enlarged space 17 and the chamber 11 thereof. The housing 10 further includes one or more ribs 20 extended into the chamber 11 thereof (FIGS. 3, 6), and further includes a serrated or knurled surface 21 formed or provided on the outer peripheral portion thereof (FIGS. 4-6), for being stably held or grasped by the users.

As shown in FIGS. 2, 3 and 7, an inner casing 30 is engaged into the chamber 11 of the housing 10, and includes a stud 31 extended therefrom, such as extended from one end 32 thereof, for engaging into the bore 14 of the housing 10, and includes a peripheral flange 33 extended outwardly from the outer peripheral portion of the stud 31, for engaging with the hook 16 of the housing 10, and thus for detachably attaching or securing the inner casing 30 to the housing 10. The inner casing 30 also includes a bore 34 formed in the stud 31 thereof, for receiving such as electric wires or cables therein (not shown).

The inner casing 30 further includes one or more recesses or notches 35 formed in the outer peripheral portion thereof (FIG. 7), for receiving the ribs 20 of the housing 10, and the ribs 20 may be force-fitted or engaged with the inner casing 30, for further detachably and stably attaching or securing the inner casing 30 to the housing 10. It is preferable that the inner casing 30 further includes an opening 36 formed therein, and preferably located close to the stud 31 thereof, for viewing the inner portion of the casing 30, or for viewing the electric wires or cables that are engaged through the casing 30, for example.

The casing 30 includes a compartment 37 formed therein for receiving a coupler 50 therein, and includes the other end 38 having an outer diameter greater than that of the casing 30, for forming an outer peripheral shoulder 39 in the outer peripheral portion thereof, and for engaging with the inner peripheral shoulder 19 of the housing 10, and thus for anchoring or positioning the casing 30 to the housing 10 (FIG. 2), and/or for limiting the casing 30 to slide or to move relative to the housing 10. The other end 38 the casing 30 is provided for receiving and for attaching to the plug or coupling member 81 of the electric facility 80.

The casing 30 further includes one or more slits 40 formed in the other end 38 thereof, for forming one or more spring blades 41 in the other end 38 thereof, and for increasing the resilience of the other end 38 thereof, and further includes one or more protrusions 43 extended outwardly therefrom (FIGS. 2, 3 and 8) for engaging with the housing 10, and thus for further stably anchoring or positioning the casing 30 to the housing 10. For example, when the plug or coupling member 81 of the electric facility 80 is engaged into the other end 38 of the casing 30, the coupling member 81 may engage with and may force the spring blades 41 and the protrusions 43 of the casing 30 to engage with the housing 10, and to stably attach or secure the casing 30 and the housing 10 to the coupling member 81 of the electric facility 80.

The coupler 50 includes a non-conductive outer receptacle 51 for being force-fitted or engaged within the compartment 37 of the casing 30, and a conductive member 52 engaged in the outer receptacle 51, for electrically coupling to the coupling member 81 of the electric facility 80, and also for electrically coupling to the antenna member 8 with such as the electric wires or cables therein (not shown), and thus for allowing the antenna member 8 to be easily and readily and electrically coupled to the electric facility 80 with the attaching device 1.

In assembling the attaching device 1 for antenna in accordance with the present invention, as shown in FIGS. 2 and 3, the casing 30 may be easily engaged into the chamber 11 of the housing 10, and attached or secured to the housing 10 with a securing means that includes the stud 31 and the peripheral flange 33 and the hook 16 of the housing 10, and/or the force-fitted engagement of the ribs 20 of the housing 10 with the casing 30. The electric wires or cables may first be coupled to the conductive member 52 of the coupler 50, and then engaged through the bore 34 of the casing 30 and the bore 14 of the housing 10, before the coupler 50 is engaged into the compartment 37 of the casing 30.

In attaching or coupling the antenna member 8 to the electric facility 80, as shown in FIG. 1, the antenna member 8 may be easily and readily and rotatably or pivotally coupled or attached to the projection 12 of the housing 10, and the other end 18 of the housing 10 and/or the other end 38 of the casing 30 may then be easily and readily plugged or engaged onto the plug or coupling member 81 of the electric facility 80, for allowing the antenna member 8 to be easily and readily and electrically coupled to the electric facility 80 with the attaching device 1.

Accordingly, the attaching device for antenna in accordance with the present invention includes an improved structure for allowing the antenna members to be easily and readily coupled to various electric facilities.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An attaching device for attaching an antenna member to a coupling member of an electric facility, said attaching device comprising:
a housing including a chamber formed therein, and including a first end having a projection extended therefrom, for coupling to the antenna member, and including a bore formed in said first end thereof, for receiving an electric cable therein, and including a second end for attaching to the electric facility,
a casing engaged into said chamber of said housing, and secured to said housing, and including a first end having a bore formed therein for receiving the electric cable therein, and including a compartment formed therein, and including a second end for attaching to the coupling member of the electric facility, and
a coupler received in said compartment of said casing, and including a receptacle engaged in said compartment of said casing, and a conductive member engaged in said receptacle for electrically coupling to the coupling member of the electric facility and the antenna member.

2. The attaching device for antenna as claimed in claim 1, wherein said housing includes a hook provided in said first end thereof, and said casing includes a stud extended therefrom for engaging with said hook, and for attaching said casing to said housing.

3. The attaching device for antenna as claimed in claim 2, wherein said housing includes a protrusion extended into said chamber thereof from said first end thereof, and having said hook extended therefrom.

4. The attaching device for antenna as claimed in claim 3, wherein said stud of said casing is engaged into said protrusion of said housing, and includes a peripheral flange extended outwardly from said stud, for engaging with said hook of said housing, and for attaching said casing to said housing.

5. The attaching device for antenna as claimed in claim 1, wherein said housing includes at least one rib extended into said chamber thereof, fur engaging with said casing and for attaching said casing to said housing.

6. The attaching device for antenna as claimed in claim 5, wherein said casing includes at least one notch formed therein for receiving said at least one rib of said housing.

7. The attaching device for antenna as claimed in claim 1, wherein said casing includes an opening formed therein for viewing an inner portion of said casing.

8. The attaching device for antenna as claimed in claim 1, wherein said housing includes an enlarged space formed in said second end thereof, and having an inner diameter greater than that of said chamber thereof, for forming an inner peripheral shoulder therein, and said second end of said casing includes an outer diameter greater than that of said casing for forming an outer peripheral shoulder and for engaging with said inner peripheral shoulder of said housing, and for anchoring said casing to said housing.

9. The attaching device for antenna as claimed in claim 1, wherein said second end of said casing includes at least one slit formed therein for forming at least one spring blade therein, and for increasing a resilience of said second end of said casing.

10. The attaching device for antenna as claimed in claim 1, wherein said casing includes at least one protrusion extended outwardly from said second end thereof, for engaging with said housing and for stably anchoring said casing to said housing.
